(19) United States
(12) Patent Application Publication
(10) Pub. No.: US 2011/0022293 A1
(43) Pub. Date: Jan. 27, 2011

(54) Method of Locating and Managing Elements in the Built Environment

(76) Inventors: Pulkit Sharma, New Delhi (IN); Haresh Vazirani, New Delhi (IN)

Correspondence Address: PCT LAW GROUP, PLLC, 600 13th street NW, SUITE 790, WASHINGTON, DC, 20005, US

(21) Appl. No.: 12/560,050

(22) Filed: Sep. 15, 2009

(30) Foreign Application Priority Data
Jul. 27, 2009 (IN) 1546/DEL/2009

(51) Int. Cl. G06F 17/30; G01C 21/00

(52) U.S. Cl. 701/200; 707/E17.014; 707/E17.005

(57) ABSTRACT

A method and system for locating an element from one or elements in a built environment is provided. The element can be located during one of a built phase, a partially built phase and an under-construction phase of the built environment. The method includes assigning a unique ID corresponding to each of the one or elements of the built environment. Thereafter, the method includes positioning the one or elements by linking the unique ID to one or more location attributes corresponding to each of the one or more elements. Further, the method includes extracting one or location attributes of an element to be located in the built environment. Finally, the method includes locating the element on a digital representation of the built environment. Further, the data corresponding to the one or more elements can be managed.

### CROSS-REFERENCE TO RELATED APPLICATIONS

This Application claims the benefit of, and is related to, Applicants' co-pending Indian Patent Application No. 1546/DEL/2009 titled, “Method of Locating and Managing Elements in the Built Environment,” filed on Jul. 27, 2009, which is incorporated by reference herein in its entirety.

### FIELD OF THE INVENTION

The present invention relates to location systems in general. More specifically, the present invention provides a system and method for managing data corresponding to the element throughout the entire lifecycle of the built environment.

### BACKGROUND OF THE INVENTION

Positioning systems are becoming widely popular as being important in today's society. Structures such as big hospitals, factories, big hotels or large buildings, which have hundreds of rooms, currently desire the ability to locate a room, a window, a door, Mechanical electrical and plumbing (MEP) or even inventory for people who may require assistance in reaching their intended destination. For example, a person who has to handle multiple doors for maintenance reasons or handling over inspection will try to locate the door using the co-ordinates of the door. A try to locate them physically just on the basis of drawing representation can be cumbersome, time-consuming and error-prone. The person might end up checking some other door instead of checking the faulty door. Further, the person may also need floor plans, as builts or other disjointed sets of information which needs human skill based co-ordination.

There are existing technologies which help in positioning an object indoors. Examples of such technologies include, but are not limited to, Wi-Fi, Radio Frequency (RF) tagging, Advanced GPS, other Ultra wide band technologies and ultrasound based technologies. But such technologies have not been used to manage the complete lifecycle of a building by positioning each element of the building in the building phase itself. It does not solve the construction, Infrastructure (Built Environment) and Facilities management services Industries biggest problem of positioning as well as understanding building attributes simultaneously.

In the light of the foregoing discussion, there is a need for an invention, which can integrate positioning with data management and progress management, thus automating one of the most time consuming process on any project. Further, there is a need for a method and system which can use an indoor positioning technology to position each element of a building, and manage the complete lifecycle of the building. Further, there is need for a method and system for managing data of the elements of a building during the entire lifecycle of the building.

### SUMMARY OF THE INVENTION

Accordingly, it is an object of the present invention to provide a method and system for locating an element from one or more elements during the lifecycle of a built environment.

It is another object of the present invention to provide a method and system for managing data of one or more elements of a built environment during the entire lifecycle of the built environment.

It is yet another object of the invention to position one or in more elements in a built environment.

The above and other objects of the present invention are achieved by providing a method and system for locating an element and managing data corresponding to the element in a built environment during the entire lifecycle of the built environment.

In accordance with an aspect of the present invention, the invention provides a method and system for locating an element from one or elements in a built environment. The element can be located during one of a built phase, a partially built phase and an under-construction phase of the built environment. A unique ID is assigned corresponding to each of the one or elements of the built environment. Thereafter, the one or elements are positioned by linking the unique ID to one or more location attributes corresponding to each of the one or more elements. Further, an element is scanned from the one or more elements. Subsequently, one or more location attributes of an element to be located in the built environment are extracted. Finally, the element is located on a digital representation of the built environment

In accordance with another aspect of the present invention, the invention provides a method and system for managing data corresponding to one or more elements present in the built environment. Each of the one or more elements is associated with a unique ID. The unique ID is linked electronically to one or more location attributes corresponding to each of the one or more elements. Initially, an element to be located from the one or more elements in the built environment is scanned. Thereafter, the one or more location attributes of the element are extracted. Further, the element is located on a digital representation of the built environment. Finally, the data corresponding to the one or elements can be managed, wherein the data comprises information about the element.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 illustrates an environment in which various aspects of the present invention may be practised.

FIG. 2 illustrates various components of the system, in accordance with an aspect of the present invention.

FIG. 3 illustrates various components of the system, in accordance with another aspect of the present invention.

FIGS. 4a, 4b, 4c and 4d depict a method of locating and managing an element, in accordance with an aspect of the present invention

FIG. 5 shows a flowchart for locating an element in the built environment, in accordance with an aspect of the present invention.

FIG. 6 shows a flowchart for locating an element in the built environment, in accordance with another aspect of the present invention.

FIG. 7 shows a flowchart for managing data corresponding to the one or more elements in the built environment, in accordance with an aspect of the present invention.

FIG. 8 shows a flowchart for checking an element for correct location and specifications, in accordance with an aspect of the present invention.

FIG. 9 shows a flowchart for providing shortest possible route to correct location of the element, in accordance with an aspect of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of aspects of the present invention.

### DETAILED DESCRIPTION OF THE DRAWINGS

Before describing in detail the particular method and system for locating an element and managing data corresponding to the element in accordance with an aspect of the present invention, it should be observed that the present invention resides primarily in combinations of method and system components related to locating and managing device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

The present invention illustrates a method and system for locating an element in the built environment. Specifically, the present invention aims at providing a method and system for locating an element in the built environment and managing data corresponding to the element during the entire lifecycle of the built environment. The entire lifecycle of the built environment comprises of one or more phases of the built environment such as built phase, a partially built phase and an under-construction phase. The built environment of the present invention comprises of one or more elements. A unique ID is associated corresponding to each of the one or more elements. The unique ID is linked electronically to one or more location attributes corresponding to each of the one or more elements. An element to be located is scanned. The scanning operation comprises performing one of a keyword search, visual search and a unique ID search for the element. Thereafter, the one or more location attributes corresponding to the scanned element are extracted. Finally, the element is located on a digital representation of the built environment. Further, the data corresponding to the element can be managed through one or more operations.

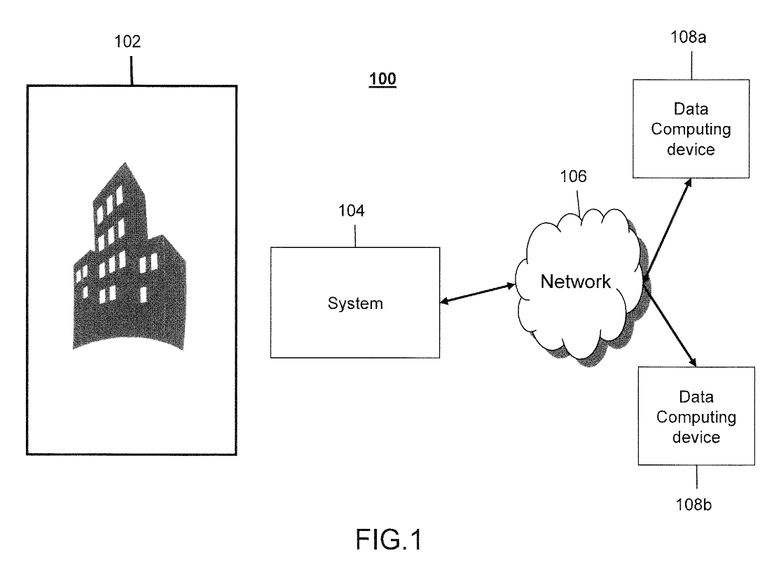

FIG. 1 illustrates an environment 100 in which various aspects of the present invention may be practised. Environment 100 includes a built environment 102, a system 104, a network 106, one or more data computing devices such as a data computing device 108a and 108b, hereinafter collectively referred to as data computing device 108. Examples of the built environment include, but are not limited to, a building, an auditorium, and a stadium. The built environment 102 comprises of one or more elements. The one or more elements are the components constituting the built environment. Examples of the one or more elements include, but are not limited to, a door, a window, floor tiles, furniture, MEP systems, emergency equipments, and structural elements. Examples of the structural elements include, but are not limited to, beams, column, and slabs. The one of the one or more elements are assigned a unique ID.

A unique ID is linked electronically corresponding to each of the one or more elements. The unique ID is linked to one or more location attributes corresponding to the element. Example of the one or more location attributes includes, but is not limited to, coordinates specifying the location of the element.

According to an aspect of the present invention, each of the one or more elements is assigned the unique ID during the designing phase of the built environment.

According to another aspect of the present invention, at least one of the one or more elements does not have a unique ID and is associated electronically to the unique ID of another element from the one or more elements. For example, a sofa in a room is associated with the unique ID of the room.

According to yet another aspect of the present of the present invention, an object carrying the unique ID is embedded corresponding to each of the one or more elements.

According to still another aspect, the unique ID is a digital ID associated corresponding to each of the one or more elements in a digital representation of the built environment.

The system 104 is capable of locating an element from the one or elements present in the built environment 102. The location can be done during either one of a construction phase, an inspection phase, a maintenance phase and a demolition phase. Further, the system 104 is capable of managing data corresponding to the one or more elements. The system 104 is a data processing device. Examples of the system 104 include, but are not limited to, a computer, laptop, PDA, and a handheld device.

According to an aspect of the present invention, the system 104 is a handheld device comprising a display, a user interface and possessing data processing capabilities.

The system 104 is connected to a data computing device 108 through network 106. Examples of the network 106 include, but are not limited to, internet, intranet, GPRS, and 3G.

According to one of the aspects of the present invention, the network 106 is a conglomeration of networks.

According to another aspect of the present invention, the network 106 is IPv6 and IPv4 compatible internet.

The system 104 is capable of transferring data corresponding to the one or more elements to and fro from the data computing device 108 through the network 106.

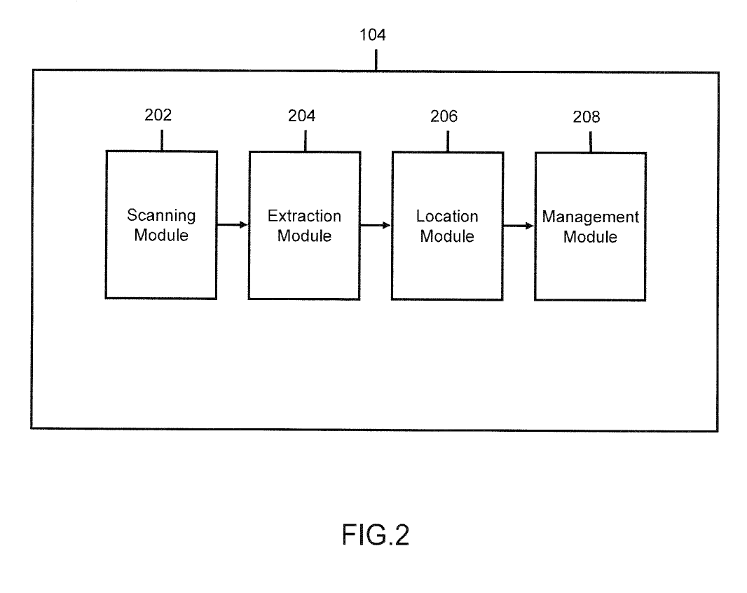

FIG. 2 illustrates various components of the system 104, in accordance with an aspect of the present invention. The system 104 includes a scanning module 202, an extraction module 204, a location module 206 and a management module 208. The scanning module 202 scans an element to be located from the one or more elements in the built environment. The scanning module 202 is capable of performing one of a keyword search, visual search and a unique ID search for the element

According to an aspect of the present invention, the scanning module 202 comprises a search module. The search module enables a user to perform one of a keyword search and a unique ID number search to locate the element.

The extraction module 204 extracts one or more location attributes of the scanned element. Examples of the one or more location attributes include, but are not limited to, the coordinates specifying the location of the element.

According to an aspect, the one or more location attributes are extracted from a database storing data of the one or more elements. The database being present in the network 106.

Thereafter, the location module 206 locates the element on a digital representation of the built environment.

According to an aspect of the present invention, the digital representation of the built environment is CAD drawing.

The management module 208 manages the data corresponding to the element and allows the user to perform one or more operations with the data corresponding to the element. Examples of the one or more operations include tracking the element with respect to one of checking, inspecting, viewing, reviewing, and compiling of the data corresponding to the element.

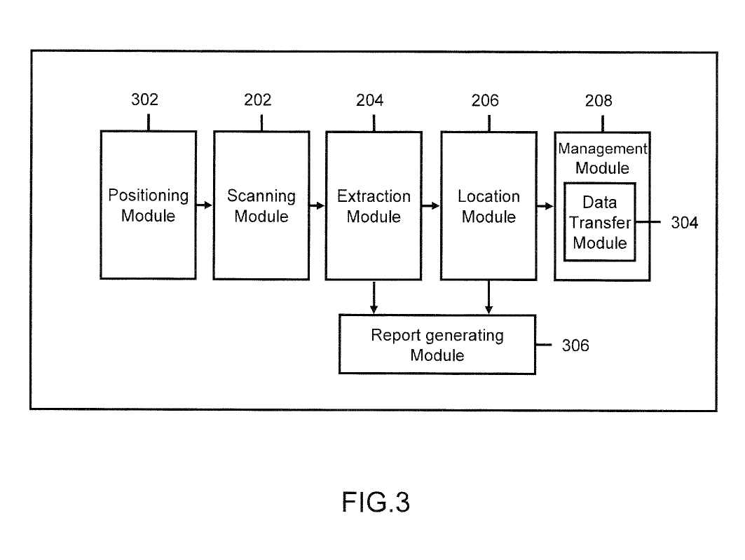

FIG. 3 illustrates various components of the system 104, in accordance with another aspect of the present invention. The system 104 includes a positioning module 302, a data transfer module 304, a report generating module 306, the scanning module 202, the extraction module 204, the location module 206 and the management module 208. The management module 208 includes the data transfer module 304. The positioning module 302 positions the one or more elements by linking the unique ID to one or more location attributes corresponding to each of the one or more elements. The data transfer module 304 transfers the data to and fro from the system 104 to the data computing device 108. The report generating module 306 generates reports corresponding to the element.

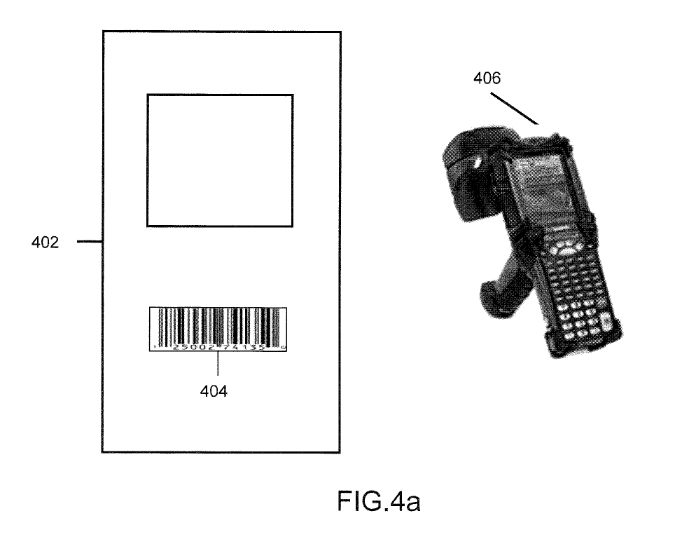

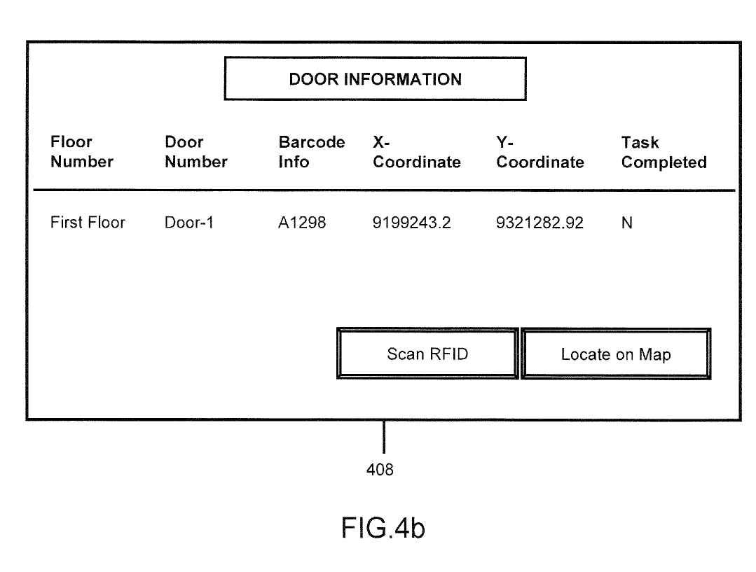

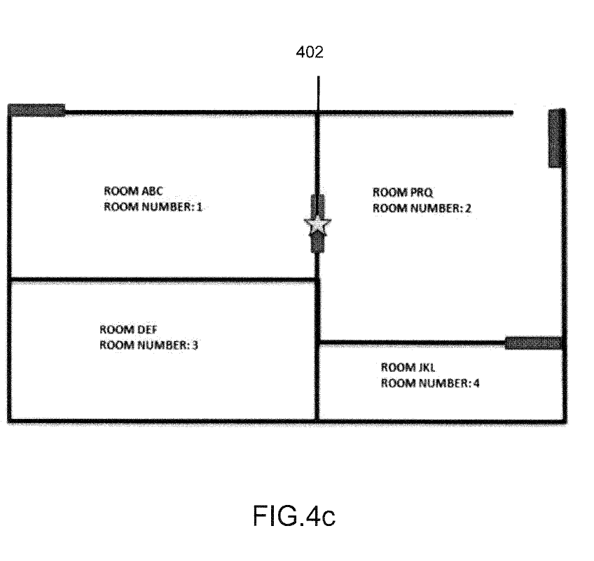

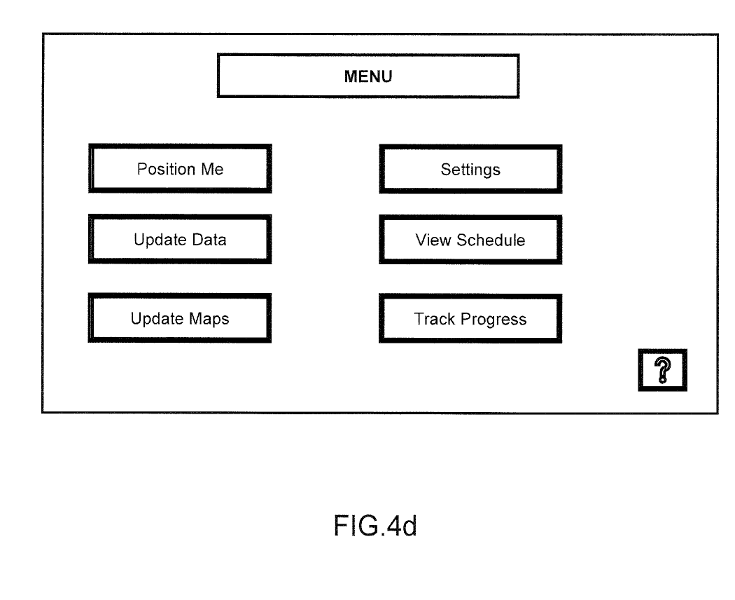

FIGS. 4a, 4b, 4c and 4d depict a method of locating and managing element, in accordance with an aspect of the present invention. FIG. 4a shows an clement such as a door 402, an object such as a Radio frequency (RF) tag 404 and a handheld device 406. The door 402 includes the RF tag 404 possessing a unique ID. The handheld device 406 scans the RF tag 402 and extracts the one or more location attributes corresponding to the door 402. FIG. 4b shows a display 408 of the handheld device displaying the one or more location attributes corresponding to the door 402. Examples of the one or more location attributes include and are not limited to information such as floor number, door number, barcode information, coordinates and status with respect to a task related to the door 402. FIG. 4c shows the display 408 displaying correct location of the door 402 on a digital map of the built environment. FIG. 4d shows the display 408 of the handled device according to an aspect of the invention. The display 408 displays one or more operations which can be performed with the data corresponding to the door 402. The one or more operations include positioning a user based on the current location of the user on digital representation of the built environment, updating data, viewing schedule, track progress, edit settings and updating map corresponding to the element.

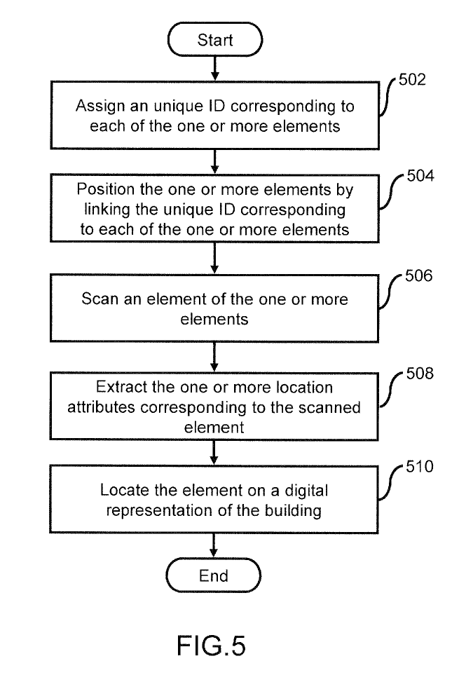

FIG. 5 shows a flowchart for locating an element in the built environment according to an aspect of the present invention. At step 502, a unique ID corresponding to each of the one or more elements is assigned during the designing phase. Thereafter, at step 504 the one or more elements are positioned by linking the unique ID corresponding to each of the one or more elements. The unique ID is linked electronically to one or more location attributes corresponding to the one or more elements.

According to an aspect of the present invention, an object carrying the unique ID is embedded corresponding to each of the one or more elements. Examples of the object include, but are not limited to, a RFID tag.

According to another aspect, the object is an electronically visible representation on the digital representation of the built environment.

At step 506, an element to be located from the one or more elements is scanned. For or the purpose of specification, the scanning operation is equivalent to search operation to locate the element. At step 508, the one or more location attributes corresponding to the scanned element are extracted. Examples of the one or more location attributes include, but are not limited to, the coordinates specifying the location of the element, floor number of the element, size of the element, finish element area, volume, quality of the element.

According to an aspect of the present invention, one or more specifications stored corresponding to the element are also extracted. Examples of the one or more specifications include, but are not limited to, length, breadth, height, and material of the element.

Subsequently, at step 510 the element is located on a digital representation of the built environment.

According to an aspect of the present invention, the element is located on a digital drawing of the built environment.

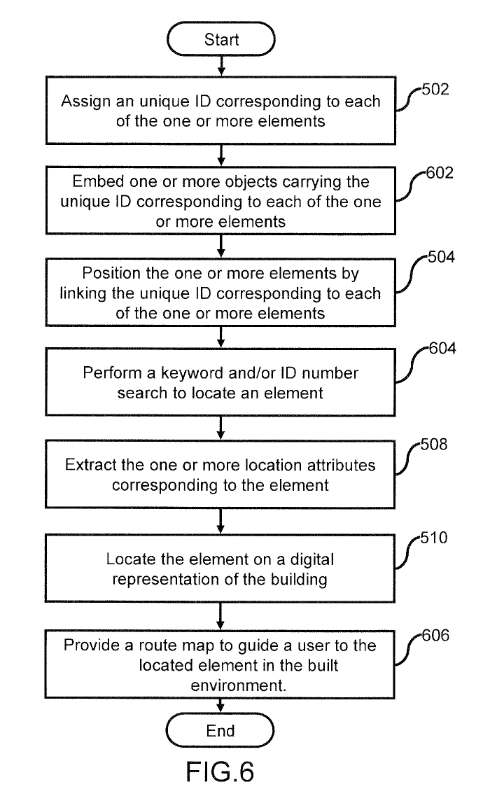

FIG. 6 shows a flowchart for locating an element in the built environment, in accordance with an aspect of the present invention. At the Step 502, a unique ID corresponding to each of the one or more elements is assigned.

According to an aspect of the present invention, the unique ID is generated and assigned corresponding to each of the one of the one or more elements.

At step 602, one or more objects carrying the unique ID are embedded corresponding to each of the one or more elements.

Thereafter, at the step 504, the one or more elements are positioned by linking the unique ID to one or more location attributes corresponding to each of the one or more elements.

According to an aspect of the present invention, the unique ID is a digital ID and the unique ID is linked to attributes of the one or more elements on the digital representation of the built environment.

At step 604, one of a keyword or a unique ID number search is performed to locate an element. The one or more location attributes corresponding to the element to be located are extracted at the step 508. Subsequently, the element is located on the digital representation of the built environment at the step 510. Finally, at step 606, a route map is provided to guide the user to the located element in the built environment from current location of the user.

According to an aspect of the present invention, the route map provides shortest and most appropriate route to the location of the element.

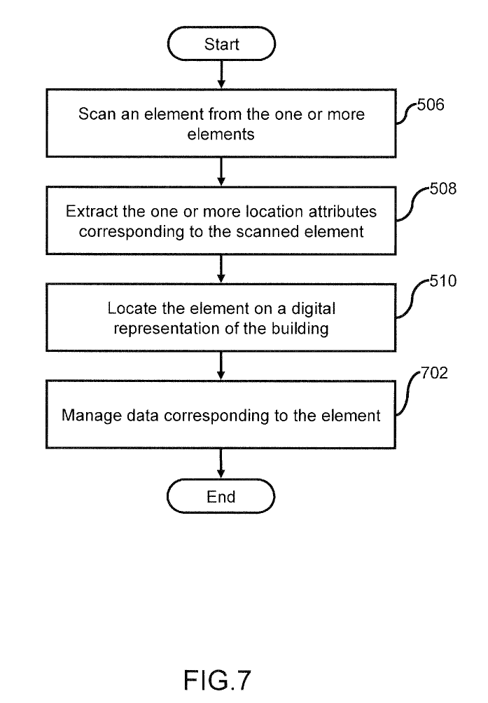

FIG. 7 shows a flowchart for managing data corresponding to the one or more elements in the built environment, in accordance with an aspect of the present invention. At the step 506, an element from the one or more elements is scanned. Thereafter, at the step 508, one or more location attributes corresponding to the element are extracted. Subsequently, at the step 510, the element is located on a digital representation of the built environment. Finally, at step 702, data corresponding to the element can be managed.

According to an aspect of the present invention, one or more operations can be performed with data corresponding to the element. Examples of the one or more operations include, but are not limited to, transfer of data from one data processing device to another, and tracking the status of the element, the tracking being done for one of checking, inspecting, viewing, reviewing, and compiling of the data corresponding to the element.

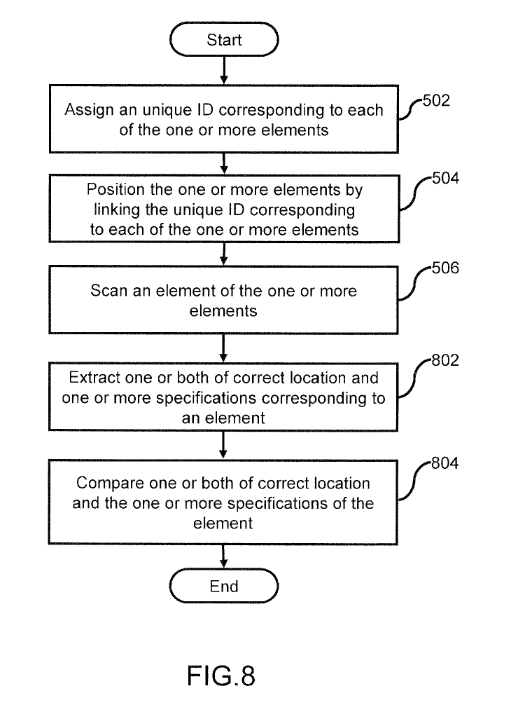

FIG. 8 shows a flowchart for checking an element for correct location and specifications, in accordance with an aspect of the present invention. At the step 502, a unique ID corresponding to each of the one or more elements is assigned. At the step 504, the one or more elements are positioned by linking the unique ID to one or more location attributes corresponding to each of the one or more elements. At the step 506, an element to be located from the one or more elements is scanned by a user. At step 802, one or both of the correct location and the one or more specifications of the element are extracted from the data stored corresponding to the element. Examples of the one or more specifications include, but are not limited to, length, breadth, height, and material of the element.

According to an aspect of the present invention, the data corresponding to the element is stored in a database. The database is remotely accessible through one or more means. Examples of the one or more means include, but are not limited to wireless, GPRS, and 3G.

At step 804, the one or both of the correct location and the one or more specifications of the element are compared with current location and existing specifications of the element.

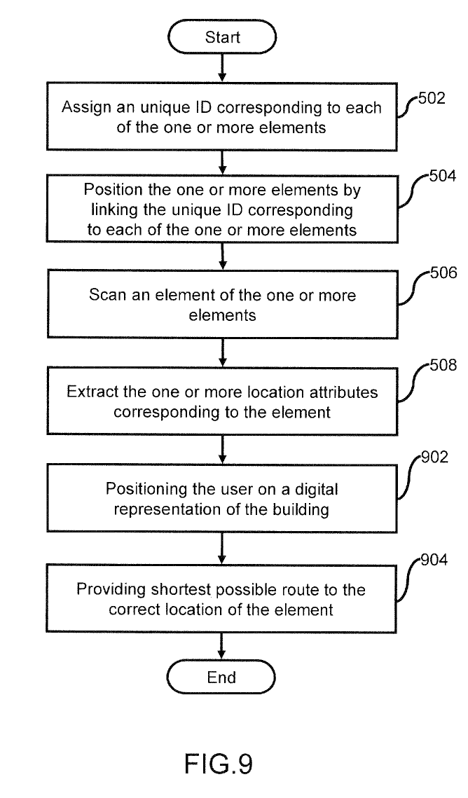

FIG. 9 shows a flowchart for providing shortest possible route to correct location of the element, in accordance with an aspect of the present invention. At the step 502, a unique ID corresponding to each of the one or more elements is assigned. At the step 504, the one or more elements are positioned by linking the unique ID to one or more location attributes corresponding to each of the one or more elements. At the step 506, an element to be located from the one or more elements is scanned by a user. At the step 508, the one or more location attributes corresponding to the element are extracted. Subsequently, at step 902, the user is positioned on the digital representation of the built environment. Finally, at step 904 the shortest possible route is provided to the user to the correct location of the element, wherein the one or more location attributes comprising the correct location of the element.

The present invention described above has a number of advantages. The method and system of the present invention caters to the entire cycle of a built environment starting from the concept phase to the final demolition of the built environment. The computer program product of the present invention is an open application which can be tailored to suit any project. Further, the present invention improves the Construction, Infrastructure and Facilities management services. For example, the present invention facilitates managing staff, checking their productivity, and keeping a record of the activities performed on an item. The invention also increases productivity by managing staff by assigning them particular tasks. Moreover, the present invention integrates positioning with data management and progress management, thereby automating the most time consuming process on any project.

The present invention has a number of industrial applications. Examples of the application include, but are not limited to, managing and implementing work packages for fit-outs and structure, work Inspection management, commissioning management, inventory control in stores, facilities management during post-construction phase, data control and management as an add-on, warehouse management, productivity enhancement and measurement for manpower in all spheres of application, analysis of movement of people and inventories for enhancing productivity, sub contractor works management, crowd management in stadiums/museums, security of assets and people in the built environment, and green technology.

The present invention can be implemented in a variety of computer languages such as Java, C, C++, Perl, Python, LISP, BASIC, and assembly. The implementation of the present invention does not require any specific platform. Any platform that can provide means of support for simple arrays and associative arrays may be used. A few examples of such platforms are Windows™, Linux and Unix™.

The computer program product of the invention is executable on a computer system for causing the computer system to perform a method of video encoding including a motion estimation method of the present invention. The computer system includes a microprocessor, an input device, a display unit and an interface to the Internet. The microprocessor is connected to a communication bus. The computer also includes a memory. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or other instructions into the computer system. The computer system also includes a communication unit. The communication unit allows the computer to connect to other databases and the Internet through an I/O interface. The communication unit allows the transfer as well as reception of data from other databases. The communication unit may include a modem, an Ethernet card, or any similar device which enables the computer system to connect to databases and networks such as LAN, MAN, WAN, Wireless, GPRS, Ultrawide band and the Internet. The computer system facilitates inputs from a user through input device, accessible to the system through I/O interface.

The computer system executes a set of instructions that are stored in one or more storage elements, in order to process input data. The set of instructions may be a program instruction means. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

While the present invention has been described in connection with preferred aspects, it will be understood by those skilled in the art that variations and modifications of the preferred aspects described above may be made without departing from the scope of the invention. Other aspects will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for managing data corresponding to one or more elements of a built environment during a phase of built environment lifecycle, the built environment comprising the one or more elements, each of the one or more elements being associated with a Unique ID, the unique ID being linked electronically to one or more location attributes corresponding to each of the one or more elements, the method comprising:
a) scanning an element from the one or more elements;
b) extracting the one or more location attributes corresponding to the scanned element of the one of the one or more elements of the built environment;
c) locating the element from the one or more elements, the element being located on a digital representation of the built environment; and
d) managing data corresponding to the element the data comprising information about the element.

2. The method according to claim 1, wherein the phase is one of a built phase, a partially built phase and an under-construction phase.

3. The method according to claim 1, wherein the unique ID is a digital ID, the digital ID being linked to the one or more elements on a digital representation of the built environment.

4. The method according to claim 1, wherein the unique ID is embedded in one or more objects, the one or more objects carrying the unique ID corresponding to each of the one or more elements, wherein the one or more objects are a unique identification device comprising pre-fed data.

5. The method according to claim 1, wherein scanning the element comprises performing one of a keyword search and a unique ID number search.

6. The method according to claim 1 further comprising generating reports corresponding to the element of the one of the one or more elements.

7. The method according to claim 1, wherein locating the element is performed by a data processing device.

8. The method according to claim 1 further comprising providing a route map, the route map guiding a user to the located element in the built environment.

9. The method according to claim 1, wherein managing the data of the element comprises tracking the status of the element, the tracking being done for one of checking, inspecting, viewing, reviewing, compiling of data corresponding to the element.

10. A system for managing data corresponding to one or more elements of a built environment during a phase of built environment lifecycle, the built environment comprising the one or more elements, each of the one or more elements being associated with a Unique ID, the unique ID being linked electronically to one or more location attributes corresponding to each of the one or more elements, the system comprising:
a) a scanning module, the scanning module scanning an element from the one or more elements
b) an extraction module, the extraction module extracting the one or more location attributes corresponding to the scanned element of the one of the one or more elements of the built environment; and
c) a location module, the locating module locating the clement from the one or more elements, the element being located on a digital representation of the built environment.
d) a management module, the managing module managing data corresponding to the element, the data comprising information about the element.

11. The system according to claim 10 further comprising a positioning module, the positioning module positioning the one or more elements by linking the unique ID corresponding to each of the one or more elements.

12. The system according to claim 10 further comprising a report generating module, the report generating module generating reports corresponding to the element.

13. The system according to claim 10, wherein management module comprises a data transfer module, the data transfer module transferring the data to and fro from one data processing device to a second data processing device.

14. A computer program product for use with a computer, the computer program product comprising a computer storage medium having a computer readable program code assigned therein for managing data corresponding to one or more elements of a built environment during a phase of built environment lifecycle, the built environment comprising the one or more elements, each of the one or more elements being associated with a Unique ID, the unique ID being linked electronically to one or more location attributes corresponding to each of the one or more elements, the computer program code performing the steps of:
a) scanning an element from the one or more elements;
b) extracting the one or more location attributes corresponding to the scanned element Of the one of the one or more elements of the built environment;
c) locating the element from the one or more elements, the element being located on a digital representation of the built environment; and
d) managing data corresponding to the element, the data comprising information about the element.

15. The computer program product according to claim 14, wherein the phase is one of a built phase, a partially built phase and an under-construction phase.

16. The computer program product according to claim 14, wherein the unique ID is a digital ID, the digital ID being linked to the one or more elements on the digital representation of the built environment.

17. ''he computer program product according to claim 14, wherein the unique ID is embedded in one or more objects, the one or more objects carrying the unique ID corresponding to each of the one or more elements, wherein the one or more objects are a unique identification device comprising pre-fed data.

18. The computer program product according to claim 14, wherein scanning the element comprises performing one of a keyword search and a unique ID number search.

19. The computer program product according to claim 14 further comprising providing a route map, the route map guiding a user to the located element in the built environment.

20. The computer program product according to claim 14, wherein managing the data of the element comprises tracking the status of the element, the tracking being done for one of checking, inspecting, viewing, reviewing, generating reports and compiling of data corresponding to the element.
